(19) United States
(12) Patent Application Publication
(10) Pub. No.: US 2015/0319676 A1
(43) Pub. Date: Nov. 5, 2015

(54) NARROW BANDWIDTH SIGNAL REJECTION

(71) Applicant: QUALCOMM Incorporated, San Diego, CA (US)

(72) Inventors: Awlok Singh JOSAN, San Francisco, CA (US); Clarence Kar Lun Wong, San Diego, CA (US)

(21) Appl. No.: 14/517,141

(22) Filed: Oct. 17, 2014

Related U.S. Application Data
(60) Provisional application No. 61/986,557, filed on Apr. 30, 2014.

(51) Int. Cl. H04W 48/16; H04B 17/20

(52) U.S. Cl. CPC H04W 48/16; H04B 17/20

(57) ABSTRACT

Methods and apparatus are described for performing a cell search procedure. For example, the methods and apparatus may include making multiple signal power measurements over multiple bandwidths on a wideband frequency channel, where the signal power measurements may correspond to a signal received on the wideband frequency channel. Further, the methods and apparatus may further include performing a narrowband rejection procedure based on the signal power measurements, where the narrowband rejection procedure may determine whether the signal power measurements correspond to a narrowband signal or a wideband signal. Moreover, the methods and apparatus may also include continuing a wideband cell search procedure on the wideband frequency channel based on the narrowband rejection procedure determining that the signal power measurements correspond to the wideband signal.

### CLAIM OF PRIORITY

The present application for patent claims priority to Provisional Application No. 61/986,557 entitled “METHOD AND APPARATUS FOR NARROW BANDWIDTH SIGNAL REJECTION” filed Apr. 30, 2014, and assigned to the assignee hereof and hereby expressly incorporated by reference herein.

### BACKGROUND

Aspects of the present disclosure relate generally to wireless communication systems, and more particularly, to identify and reject narrow bandwidth signals.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In W-CDMA, a user equipment (UE) may search for W-CDMA cells and initiate initial acquisition of a given wireless communication channel when a signal detected on the channel reads higher than a certain threshold. In environments having crowded radio frequency (RF) conditions (e.g., many different radio signals), however, the presence of signals from other communication technologies (e.g., GSM) can cause the received signal level to go above the threshold in which W-CDMA initiates initial channel acquisition. Thus, the presence of these other signals can trigger spurious W-CDMA acquisition procedures.

Thus, improvements in performing a cell search procedure and initiating acquisition of a wireless communication channel are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, methods and apparatus for identifying and rejecting narrow bandwidth signals. The methods and apparatus include making a plurality of signal power measurements over a plurality of bandwidths on a wideband frequency channel, wherein the plurality of signal power measurements correspond to a signal received on the wideband frequency channel. Further, the methods and apparatus include performing a narrowband rejection procedure based on the plurality of signal power measurements, wherein the narrowband rejection procedure determines whether the plurality of signal power measurements correspond to a narrowband signal or a wideband signal. Moreover, the methods and apparatus include continuing a wideband cell search procedure on the wideband frequency channel based on the narrowband rejection procedure determining that the plurality of signal power measurements correspond to the wideband signal.

In an aspect, a method at a user equipment for performing a cell search procedure during wireless communications, comprising making a plurality of signal power measurements over a plurality of bandwidths on a wideband frequency channel, wherein the plurality of signal power measurements correspond to a signal received on the wideband frequency channel; performing a narrowband rejection procedure based on the plurality of signal power measurements, wherein the narrowband rejection procedure determines whether the plurality of signal power measurements correspond to a narrowband signal or a wideband signal; and continuing a wideband cell search procedure on the wideband frequency channel based on the narrowband rejection procedure determining that the plurality of signal power measurements correspond to the wideband signal.

In another aspect, a computer-readable medium storing computer executable code at a user equipment for performing a cell search procedure during wireless communication, comprising code for making a plurality of signal power measurements over a plurality of bandwidths on a wideband frequency channel, wherein the plurality of signal power measurements correspond to a signal received on the wideband frequency channel; code for performing a narrowband rejection procedure based on the plurality of signal power measurements, wherein the narrowband rejection procedure determines whether the plurality of signal power measurements correspond to a narrowband signal or a wideband signal; and code for continuing a wideband cell search procedure on the wideband frequency channel based on the narrowband rejection procedure determining that the plurality of signal power measurements correspond to the wideband signal.

Further, in an aspect, apparatus at a user equipment for performing a cell search procedure during wireless communication, comprising means for making a plurality of signal power measurements over a plurality of bandwidths on a wideband frequency channel, wherein the plurality of signal power measurements correspond to a signal received on the wideband frequency channel; means for performing a narrowband rejection procedure based on the plurality of signal power measurements, wherein the narrowband rejection procedure determines whether the plurality of signal power measurements correspond to a narrowband signal or a wideband signal; and means for continuing a wideband cell search procedure on the wideband frequency channel based on the narrowband rejection procedure determining that the plurality of signal power measurements correspond to the wideband signal.

Additionally, in an aspect, apparatus at a user equipment for performing a cell search procedure during wireless communication, comprising a measurement component configured to make a plurality of signal power measurements over a plurality of bandwidths on a wideband frequency channel, wherein the plurality of signal power measurements correspond to a signal received on the wideband frequency channel; a cell acquisition component configured to perform a narrowband rejection procedure based on the plurality of signal power measurements, wherein the narrowband rejection procedure determines whether the plurality of signal power measurements correspond to a narrowband signal or a wideband signal; and wherein the cell acquisition component is further configured to continue a wideband cell search procedure on the wideband frequency channel based on the narrowband rejection procedure determining that the plurality of signal power measurements correspond to the wideband signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify corresponding components or actions throughout, where dashed lines may indicate optional components or actions, and wherein:

FIG. 1 is a schematic diagram illustrating an example wireless system of aspects of the present disclosure;

FIG. 2 is a schematic diagram illustrating an example of an aspect of cell acquisition component of the present disclosure;

FIG. 3 is a flow diagram illustrating an exemplary method in a wireless communication system;

FIG. 4 is a flow diagram illustrating another exemplary method in a wireless communication system;

FIG. 5 is a block diagram illustrating an example of a hardware implementation for an apparatus employing a processing system;

FIG. 6 is a block diagram conceptually illustrating an example of a telecommunications system;

FIG. 7 is a conceptual diagram illustrating an example of an access network;

FIG. 8 is a conceptual diagram illustrating an example of a radio protocol architecture for the user and control plane; and

FIG. 9 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to a user equipment (UE) efficiently identifying and rejecting a narrow bandwidth (or narrowband) signal in a wireless communication network. Specifically, the UE may initiate an initial acquisition of a wide bandwidth cell, e.g. a cell transmitting a wide bandwidth (or wideband) signal, such as a cell operating according to W-CDMA standards, when a received signal power for a given wideband channel from the cell reads higher than an initial acquisition threshold (dBm). However, in environments with a large amount of radio frequency noise, the presence of narrowband signals (e.g., GSM/lx signals) may cause the received signal power level to be above the initial acquisition threshold. As such, the presence of a narrowband signal may cause the UE to continue a cell search procedure in attempt to access a wideband cell. For example, during initial wideband cell acquisition, a cell acquisition component of the UE may request a frequency scan in steps of X MHz, where X may be any specified value, and received signal power levels are measured on in each channel. Further, it is determined which of the channels measured had received signal power levels greater than the initial acquisition threshold. The channel with the highest received signal power level is presumed to be the channel where the W-CDMA signal is centered, and the cell search procedure may be continued for the channel. However, the subsequent scan may result in a narrowband signal having caused the cell search procedure to be continued. Even though the cell search procedure would eventually reject the narrowband signal during the procedure, an unnecessary amount of time and resources are wasted.

Accordingly, in some aspects, the present methods and apparatuses may provide an efficient solution, as compared to current solutions, by enabling the UE to identify and reject narrow bandwidth signals in an initial wideband cell acquisition procedure.

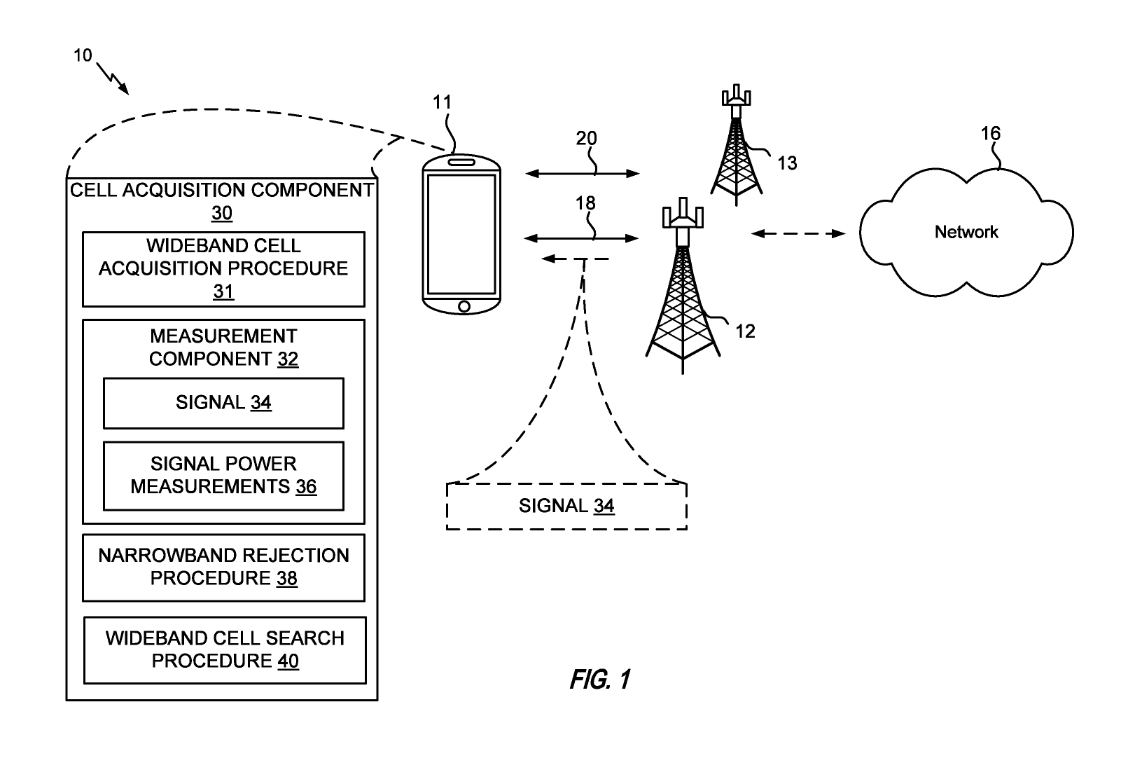

Referring to FIG. 1, in one aspect, a wireless communication system 10 is configured to allow a user equipment (UE) to identify and reject a narrow bandwidth signal received from the wireless communication network, for example, in an initial wideband cell acquisition procedure. Wireless communication system 10 includes at least one UE 11 that may communicate wirelessly with one or more networks (e.g., network 16) via one or more network entities, including, but not limited to, network entity 12. UE 11 may communicate with network 16 via network entity 12. For example, in an aspect, network entity 12 may be a base station configured to transmit and receive one or more signals (e.g., signals 34) via one or more communication channels 18 and/or 20, respectively, to/from UE 11. In an aspect, for example, communication channel 18 and/or communication channel 20 may be defined by a range of frequencies over which a signal is intended to be transmitted or received. For instance, in one case, the range of frequencies may be a wideband range (e.g., a 5 MHz range) for a wideband channel, such as a W-CDMA channel, as opposed to a narrowband range (e.g., a 200 kHz range) for a narrowband channel, such as a GSM channel. Further, for example, one or more received signals 34 may be wideband signals or narrowband signals. For instance, in one case, a wideband signal may be a signal intended for communication in a wideband channel (e.g., a signal intended to be communicated within a 5 MHz range in a W-CDMA channel), while a narrowband signal may be a signal intended for communication in a narrowband channel (e.g., a signal communicated within a 200 kHz range in a GSM channel).

As such, in certain instances, one or more communication channels 18 and/or 20 may correspond to or fall within a wideband frequency channel (e.g., a 5 MHz W-CDMA channel). For example, UE 11 may receive wideband signals such as W-CDMA signals with, for example, 5 MHz bandwidths, transmitted by network entity 12 on at least one of the one or more communication channels 18 and/or 20. On the other hand, UE 11 may receive narrowband signals such as GSM signals with, for example, 200 kHz bandwidths, transmitted by another network entity 13 on at least one of the one or more communication channels 18 and/or 20. In some instances, UE 11 may receive a plurality of narrowband signals on a wideband frequency channel. As such, according to the present aspects, UE 11 may be configured to distinguish wideband signals (e.g., W-CDMA signals) from narrowband signals (e.g., GSM signals), for example, in performing a cell search procedure and/or an initial cell acquisition procedure.

In an aspect, UE 11 may include a cell acquisition component 30 configured to execute a wideband cell acquisition procedure 31, and further configured to determine whether a received signal 34 is either a narrowband signal or a wideband signal. It should be noted that, for simplicity, received signal 34 is illustrated as being carried on channel 18, however, signal 34 may optionally or in addition be carried on channel 20. In an additional or optional aspect, a narrowband rejection procedure 38 may be performed in parallel with a wideband cell search procedure 40 that is continued after the channel with the highest received power signal is chosen. As such, cell acquisition component 30 may make a plurality of power measurements over a plurality of bandwidths on the chosen channel, and determine whether the received signal 34 is a narrowband signal or a wideband signal. If received signal 34 is a wideband signal, then wideband cell acquisition procedure 31 may continue and perform a wideband cell search procedure 40, but if received signal 34 is a narrowband signal, then wideband cell search procedure 40 may be aborted. In an additional or optional aspect, narrowband rejection procedure 38 may be performed prior to a wideband cell search procedure 40, and if received signal 34 is a wideband signal, then wideband cell search procedure 40 may be triggered.

More specifically, in an aspect, cell acquisition component 30 of UE 11 executes wideband cell acquisition procedure 31 to cause measurement component 32, such as a receiver or transceiver and related receive chain components, to perform a frequency scan on a plurality of wideband channels (e.g., communication channels 18 and/or 20), measure a received signal power on each of the plurality of wideband channels based on the frequency scan, and choose one of the plurality of wideband channels (e.g., communication channel 18) based on the received signal power on each of the plurality of wideband channels, wherein the one of the plurality of wideband channels with a highest received signal power is chosen. In certain instances, the cell acquisition component 30 may be configured to choose one of the plurality of wideband channels prior to making a plurality of signal power measurements 36 over a plurality of bandwidths on a wideband frequency channel (e.g., communication channel 18). Further, cell acquisition component 30 of UE 11 executes wideband cell acquisition procedure 31 to make a plurality of signal power measurements 36 over a plurality of bandwidths on the chosen wideband frequency channel (e.g., communication channel 18), wherein the plurality of signal power measurements correspond to one or more of signal 34 received on the wideband frequency channel (e.g., communication channel 18). In some instances, cell acquisition component 30 may be configured to make a wideband frequency measurement over a wideband frequency bandwidth corresponding to the wideband frequency channel (e.g., communication channel 18). Further, cell acquisition component 30 may be configured to make a plurality of narrowband frequency measurements over a corresponding plurality of different narrowband frequency bandwidths (e.g., different 200 kHz bandwidths) within the wideband frequency channel (e.g., communication channel 18).

In an optional or additional aspect, the wideband frequency measurement may be centered on the wideband frequency bandwidth. Moreover, the plurality of narrowband frequency measurements may be centered, rotated by a positive offset, or rotated by a negative offset on one of the corresponding plurality of different narrowband frequency bandwidths. For example, three narrowband frequency measurements may be made on one of the corresponding plurality of different narrowband frequency bandwidths. The first narrowband frequency measurement may be centered on one of the corresponding plurality of different narrowband frequency bandwidths (e.g., f1 kHz bandwidth). The second narrowband frequency measurement may be rotated by a positive offset (e.g., offset of f2 MHz) on one of the corresponding plurality of different narrowband frequency bandwidths (e.g., f1 kHz bandwidth). The third narrowband frequency measurement may be rotated by a negative offset (e.g., offset of −f2 MHz) on one of the corresponding plurality of different narrowband frequency bandwidths (e.g., f1 kHz bandwidth).

Moreover, cell acquisition component 30 may be configured to perform a narrowband rejection procedure 38 based on the plurality of signal power measurements 36, wherein the narrowband rejection procedure 38 determines whether the plurality of signal power measurements 36 correspond to a narrowband signal or a wideband signal. For example, cell acquisition component 30 may be configured to determine existence of the wideband signal or the narrowband signal based on comparing values of at least two of the wideband frequency measurement and the plurality of narrowband frequency measurements.

In an aspect, for example, narrowband rejection procedure 38 determines a minimum signal power measurement from the plurality of signal power measurements 36 and a maximum signal power measurement from the plurality of signal power measurements 36. Then, narrowband rejection procedure 38 computes a first narrowband value and a second narrowband value based on one or more of the minimum signal power signal, the maximum signal power signal, and one of the plurality of signal power measurements 36. Further, narrowband rejection procedure 38 compares the first narrowband value to a first threshold, and determines that the plurality of signals power measurements correspond to the narrowband signal when the first value exceeds the first threshold. Subsequently, narrowband rejection procedure 38 compares the second narrowband value to a second threshold when the first narrowband value fails to exceed the first threshold, and determines that the plurality of signals are narrowband signals when the second value exceeds the second threshold.

Moreover, narrowband rejection procedure 38 determines that the plurality of signal power measurements correspond to the wideband signal when the second narrowband value fails to meet or exceed the second threshold value. Alternatively, or in addition, in some aspects, narrowband rejection procedure 38 may determine whether a received signal power exceeds an initial acquisition threshold when the first narrowband value fails to exceed the first threshold, and may determine that the plurality of signal power measurements correspond to the wideband signal when the received signal power exceeds the initial acquisition threshold. As such, upon determining that the plurality of signal power measurements 36 of received signal 34 correspond to a wideband signal, cell acquisition component 30 may be configured to continue wideband cell acquisition procedure 31 and execute a wideband cell search procedure 40 on the wideband frequency channel (e.g., communication channel 18).

Additionally, in another aspect, cell acquisition component 30 may be configured to abort (or not initiate) wideband cell search procedure 40 on the wideband frequency channel (e.g., communication channel 18) based on the narrowband rejection procedure 38 determining that the plurality of signal power measurements 36 correspond to the narrowband signal. In this case, the cell acquisition component 30 may continue to perform the wideband cell acquisition procedure 31, e.g., on a different wideband channel, even after aborting (or not initiating) the wideband cell search procedure 40.

UE 11 may comprise a mobile apparatus and may be referred to as such throughout the present disclosure. Such a mobile apparatus or UE 11 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Additionally, the one or more wireless nodes, including, but not limited to, network entity 12 and/or network entity 13 of wireless communication system 10, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 10 may include one or more small cell base stations, such as, but not limited to a femtocell, picocell, microcell, or any other base station having a relatively small transmit power or relatively small coverage area as compared to a macro base station.

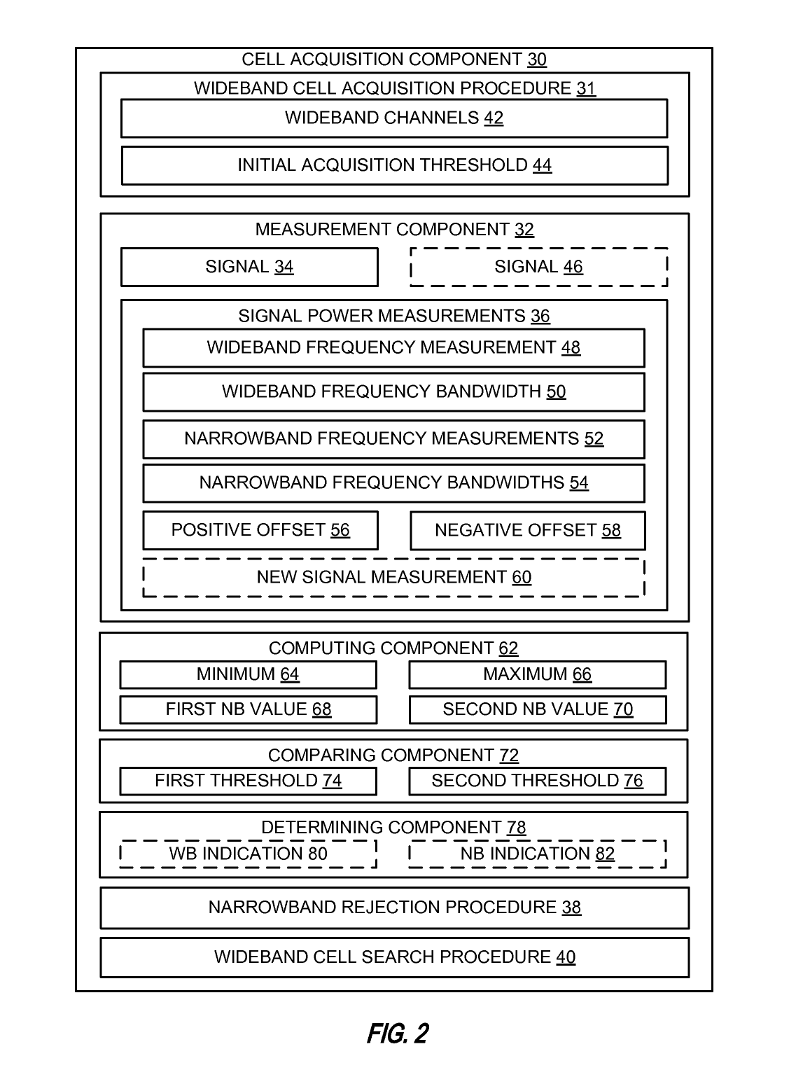

Referring to FIG. 2, an aspect of the cell acquisition component 30 may include various components and/or subcomponents that may be configured to establish whether a received signal is a narrowband signal or a wideband signal, for example, in performing a cell search procedure and/or an initial cell acquisition procedure. For instance, wideband signals such as W-CDMA signals with, for example, 5 MHz bandwidths, may be received on at least one of the one or more communication channels 18 and/or 20 (see FIG. 1). On the other hand, narrowband signals such as GSM signals with, for example, 200 kHz bandwidths, may be received on at least one of the one or more communication channels 18 and/or 20. In some instances, there may be a plurality of narrowband signals received on a wideband frequency channel. The various components/subcomponents described herein enable cell acquisition component 30 to achieve a determination about whether a received signal is a narrowband signal or a wideband signal without having to perform a wideband cell search procedure. Accordingly, cell acquisition component 30 may generally be configured to more efficiently perform wideband cell acquisition and searches by avoiding wideband cell search procedures 40 that may be erroneously triggered by narrowband signals.

In an aspect, cell acquisition component 30 may include performing a wideband cell acquisition procedure 31, which may be configured to choose a particular channel on which UE 11 (FIG. 1) may initiate a wideband cell search procedure 40. For example, cell acquisition component 30 may be configured to execute wideband cell acquisition procedure 31 to perform a frequency scan on a plurality of wideband channels 42 (e.g., communication channels 18 and/or 20 of FIG. 1). The wideband cell acquisition procedure 31 further measures a received signal power on each of the plurality of wideband channels 42 based on the frequency scan. Further, cell acquisition component 30 may continue the wideband cell acquisition procedure 31 and determine which of the measured wideband channels 42 had received signal power levels greater than the initial acquisition threshold 44. In some instances, the cell acquisition component 30 may be configured to choose the one of the plurality of wideband channels 42 meeting the initial acquisition threshold 44 and having a highest received signal power level. In certain instances, the cell acquisition component 30 may be configured to choose one of the plurality of wideband channels 42 prior to making a plurality of signal power measurements 36 over a plurality of bandwidths on a wideband frequency channel (e.g., communication channel 18).

As a result of completing the wideband cell acquisition procedure 31, cell acquisition component 30 may initialize a narrowband rejection procedure 38. For example, initializing the narrowband rejection procedure 38 triggers the cell acquisition component 30 to execute measurement component 32, computing component 62, comparing component 72, and determining component 78 to establish whether signal 34 corresponding to the wideband frequency channel (e.g., communication channel 18) is a narrowband signal or a wideband signal according to the procedures as described herein. In some instances, cell acquisition component 30 may initialize the narrowband rejection procedure 38 prior to initializing wideband cell search procedure 40. For example, cell acquisition component 30 may complete the narrowband rejection procedure 38 prior to initializing the wideband cell search procedure 40. In these instances, the outcome of the narrowband rejection procedure 38 may indicate to cell acquisition component 30 whether to initialize the wideband cell search procedure 40. In other instances, cell acquisition component 30 may initialize the narrowband rejection procedure 38 concurrently with the wideband cell search procedure 40. In these instances, cell acquisition component 30 may abort or continue the wideband cell search procedure 40 based on the outcome of the narrowband rejection procedure 38. Aborting the wideband cell search procedure 40 may include immediately terminating or concluding the wideband cell search procedure 40 before it is completed.

For instance, in one example, cell acquisition component 30 may initiate measurement component 32 to make a plurality of signal power measurements 36 over a plurality of bandwidths on a wideband frequency channel (e.g., communication channel 18). For example, measurement component 32 may make a plurality of signal power measurements 36 corresponding to signal 34 received on the wideband frequency channel (e.g., communication channel 18). In some instances, measurement component 32 may be configured to make a wideband frequency measurement 48 over a wideband frequency bandwidth 50 corresponding to the wideband frequency channel (e.g., communication channel 18). Further, measurement component 32 may be configured to make a plurality of narrowband frequency measurements 52 over a corresponding plurality of narrowband frequency bandwidths 54 within the wideband frequency channel (e.g., communication channel 18). In certain instances, the corresponding plurality of narrowband frequency bandwidths 54 may be different from one another.

In an optional or additional aspect, the wideband frequency measurement 48 may be centered on the wideband frequency bandwidth 50. Moreover, the plurality of narrowband frequency measurements 52 may be centered, rotated by a positive offset 56, or rotated by a negative offset 58 on one of the corresponding plurality of narrowband frequency bandwidths 54. For example, three narrowband frequency measurements 52 may be made by measurement component 32 on one of the corresponding plurality of narrowband frequency bandwidths 54. The first narrowband frequency measurement may be centered on one of the corresponding plurality of narrowband frequency bandwidths 54 (e.g., f1 kHz bandwidth). The second narrowband frequency measurement may be rotated by a positive offset 56 (e.g., offset of f2 MHz) on one of the corresponding plurality of narrowband frequency bandwidths 54 (e.g., f1 kHz bandwidth). The third narrowband frequency measurement may be rotated by a negative offset 58 (e.g., offset of −f2 MHz) on one of the corresponding plurality of narrowband frequency bandwidths (e.g., f1 kHz bandwidth). In some instances, the value of the positive offset 56 may equal the absolute value of the negative offset 58.

Additionally, measurement component 32 may measure an additional signal 46 at a time after making signal power measurements 36 corresponding to signal 34. Due to narrowband signals being transmitted on a Time Division Duplexing (TDD) system (e.g., GSM), a signal, such as signal 34, may have been present and detected during the previous scan, but not currently during the narrowband rejection procedure 38. For example, measurement component 32 may make a new signal measurement 60 corresponding to signal 46. In some instances, measurement component 32 may make the new signal measurement 60 at some time after making the signal power measurements 36 corresponding to signal 34. Specifically, measurement component 32 may make the new signal measurement 60 after cell acquisition component 30 executing computing component 62 and prior to cell acquisition component 30 executing comparing component 72. As such, the new signal measurement 60 may be used to ensure that a signal is present during the narrowband rejection procedure 38.

Further, cell acquisition component 30 may include computing component 62, which may be configured to compute a first narrowband value 68 and a second narrowband value 70. For example, computing component 62 may initially compute a minimum signal power 64 based on the narrowband frequency measurements 52. In some instances, cell acquisition component 30 and/or measurement component 32 may measure three narrowband frequency measurements 52. Computing component 62 may compute the minimum signal power 64 based on whichever one of the three narrowband frequency measurements 52 has the minimum value. Computing component 62 may also compute a maximum signal power 66 based on the narrowband frequency measurements 52. Similarly, computing component 62 may compute the maximum signal power 66 based on whichever one of the three narrowband frequency measurements 52 has the maximum value.

As such, computing component 62 may be configured to compute a first narrowband value 68 and a second narrowband value 70 based on one or more of the minimum signal power 64, the maximum signal power 66, and one of the plurality of signal power measurements 36. For example, first narrowband value 68 may be computed based on the minimum signal power 64 and the maximum signal power 66. Specifically, first narrowband value 68 may be computed based on a constant multiplied by a logarithmic function of a ratio of the maximum signal power 66 to minimum signal power 64. Further, second narrowband value 70 may be computed based on the maximum signal power 66 and one of the signal power measurements 36. For example, second narrowband value 70 may be computed based on the maximum signal power 66 and wideband frequency measurement 48. Specifically, second narrowband value 70 may be computed based on a constant multiplied by a logarithmic function of a ratio of the wideband frequency measurement 48 to the maximum signal power 66. As a result, cell acquisition component 30 may use the first narrowband value 68 and the second narrowband value 70 to determine whether signal 34 is a wideband signal or narrowband signal.

Additionally, cell acquisition component 30 may include comparing component 72, which may be configured to compare the first narrowband value 68 and the second narrowband value 70 with a plurality of thresholds. For example, comparing component 72 may compare whether the first narrowband value 68 satisfies a first threshold 74. Comparing component 72 may also compare whether the second narrowband value 70 satisfies a second threshold 76. Further, in an optional aspect, comparing component 72 may compare whether the new signal measurement 60 satisfies the initial acquisition threshold 44. The outcomes of these comparisons may be used by cell acquisition component 30 to determine whether signal 34 (and/or signal 46) is a wideband signal or narrowband signal.

In a further aspect, cell acquisition component 30 may include determining component 78, which may be configured to determine whether signal 34 corresponds to a wideband signal or a narrowband signal. For example, determining component 78 may determine that signal 34 is a narrowband signal when the first narrowband value 68 satisfies the first threshold 74. In instances when signal 34 is determined to correspond to a narrowband signal, determining component 78 may generate and/or transmit a narrowband indication 82. In certain instances where the wideband cell search procedure 40 is configured to execute concurrently with the narrowband rejection procedure 38, the narrowband indication 82 may trigger cell acquisition component 30 to abort the wideband cell search procedure 40. In instances where the narrowband rejection procedure 38 is configured to execute prior to the wideband cell search procedure 40, the narrowband indication 82 may trigger cell acquisition component 30 to prevent the wideband cell search procedure 40 from initiating.

In another aspect, when determining component 78 determines that the first narrowband value 68 fails to satisfy the first threshold 74, determining component 78 may then determine whether signal 34 is a narrowband signal when the second narrowband value 70 satisfies the second threshold 76. In some instances, determining component 78 may determine that signal 34 is a narrowband signal when the second narrowband value 70 satisfies the second threshold 76. In other instances, determining component 78 may determine that signal 34 is a narrowband signal when the second narrowband value 70 satisfies the second threshold 76 in combination with determining that the new signal measurement 60 satisfies the initial acquisition threshold 44. Similarly, when signal 34 is determined to correspond to a narrowband signal, determining component 78 may generate and/or transmit a narrowband indication 82.

If determining component 78 determines that the second narrowband value 70 fails to satisfy the second threshold 76 and/or determines that the new signal measurement 60 fails to satisfy the initial acquisition threshold 44, the determining component 78 may generate and/or transmit a wideband indication 80. In certain instances where the wideband cell search procedure 40 is configured to execute concurrently with the narrowband rejection procedure 38, the wideband indication 80 may trigger cell acquisition component 30 to continue the wideband cell search procedure 40. In instances where the narrowband rejection procedure 38 is configured to execute prior to the wideband cell search procedure 40, the wideband indication 80 may trigger cell acquisition component 30 to initiate the wideband cell search procedure 40.

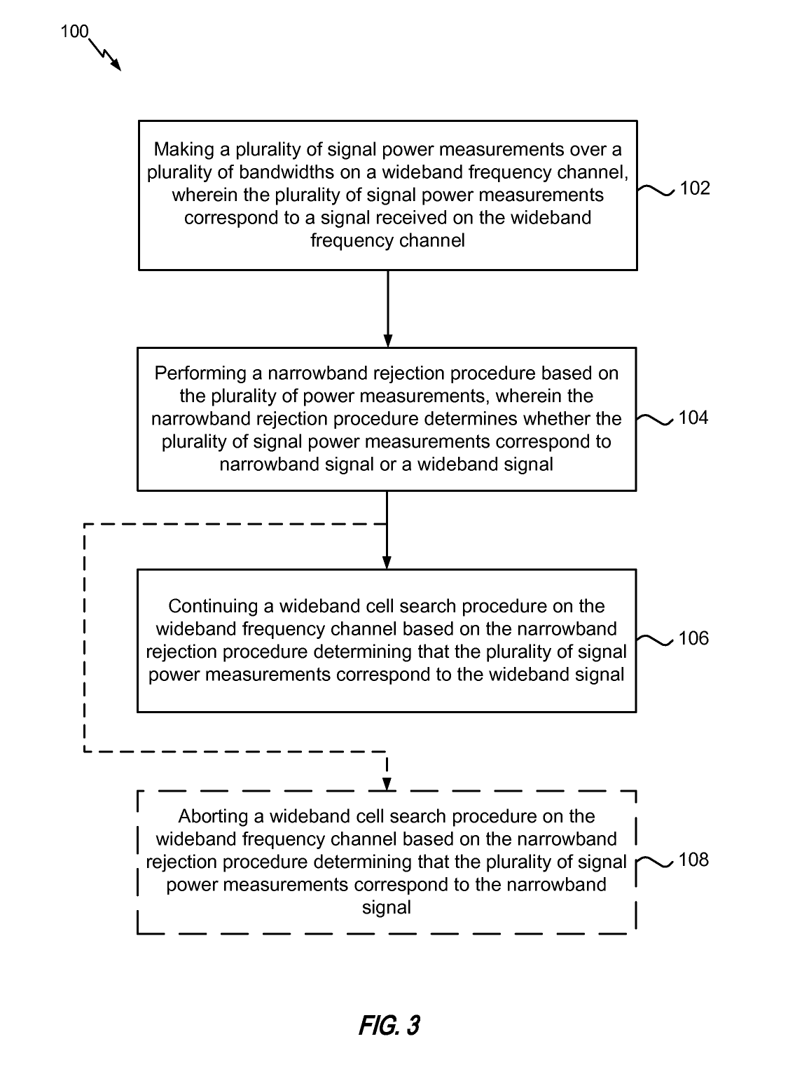

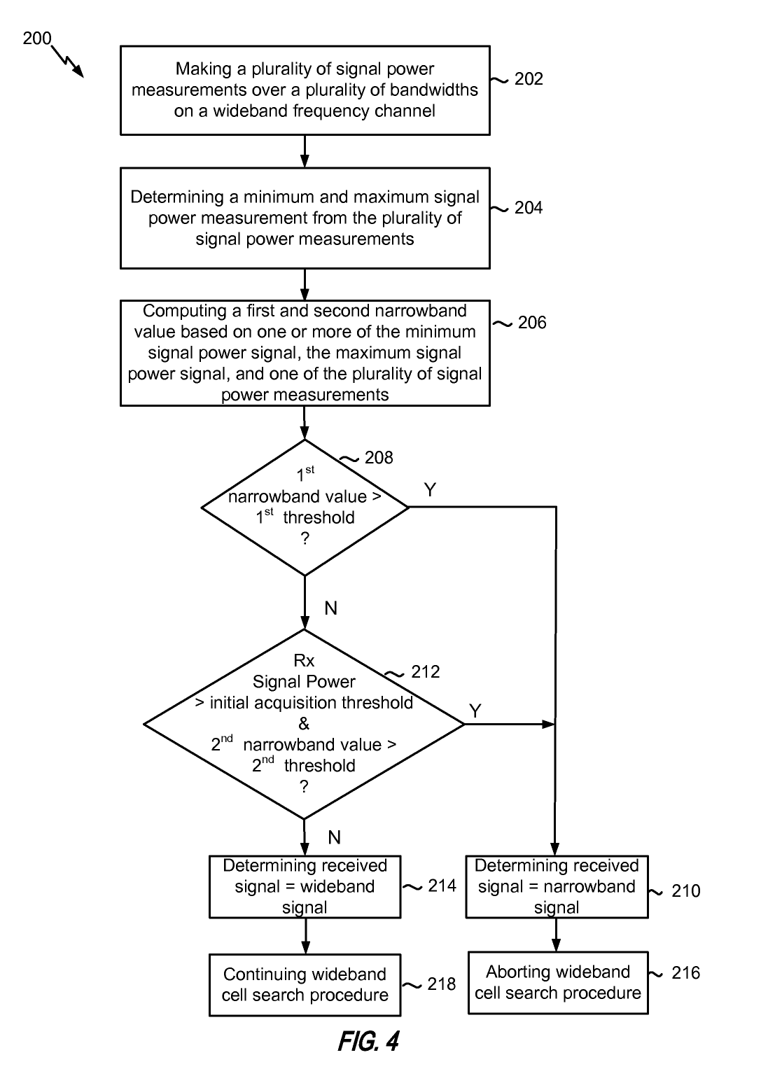

Referring to FIGS. 3 and 4, example aspects of methods according to the present disclosure are shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 3, in an operational aspect, a UE such as UE 11 (FIG. 1) may perform one aspect of a method 100 for allowing the UE 11 to identify and reject narrow bandwidth signals received from the wireless communication network 16 via network entity 12. For example, UE 11 may execute method 100 as part of wideband cell acquisition procedure 31 in order to more efficiently perform wideband cell acquisition and searches by avoiding wideband acquisition procedures that may be erroneously triggered by narrowband signals.

In an aspect, at block 102, method 100 may include making a plurality of signal power measurements over a plurality of bandwidths on a wideband frequency channel, wherein the plurality of signal power measurements correspond to a signal received on the wideband frequency channel. For example, as described herein, UE 11 (FIG. 1) may execute cell acquisition component 30 to make a plurality of signal power measurements 36 over a plurality of bandwidths on a wideband frequency channel (e.g., communication channel 18), wherein the plurality of signal power measurements 36 correspond to a signal 34 received on the wideband frequency channel (e.g., communication channel 18). Additional example aspects of performing the actions of block 102 are described in detail above with respect to FIGS. 1 and 2, and a further example is described below with respect to FIG. 4.

At block 104, method 100 may include performing a narrowband rejection procedure based on the plurality of power measurements, wherein the narrowband rejection procedure determines whether the plurality of signal power measurements correspond to narrowband signal or a wideband signal. For example, as described herein, UE 11 (FIG. 1) may execute cell acquisition component 30 to perform a narrowband rejection procedure 38 based on the plurality of signal power measurements 36, wherein the narrowband rejection procedure 38 determines whether the plurality of signal power measurements 36 correspond to narrowband signal or a wideband signal. Additional example aspects of performing the actions of block 104 are described in detail above with respect to FIGS. 1 and 2, and a further example is described below with respect to FIG. 4.

Further, at block 106, method 100 may include continuing a wideband cell search procedure 40 on the wideband frequency channel based on the narrowband rejection procedure determining that the plurality of signal power measurements correspond to the wideband signal. For example, as described herein, UE 11 (FIG. 1) may execute cell acquisition component 30 to continuing a wideband cell search procedure 40 on the wideband frequency channel (e.g., communication channel 18) based on the narrowband rejection procedure 38 determining that the plurality of signal power measurements 36 correspond to the wideband signal. Additional example aspects of performing the actions of block 106 are described in detail above with respect to FIGS. 1 and 2, and a further example is described below with respect to FIG. 4.

Additionally, at block 108, method 100 may optionally include aborting a wideband cell search procedure on the wideband frequency channel based on the narrowband rejection procedure determining that the plurality of signal power measurements correspond to the narrowband signal. For example, as described herein, UE 11 (FIG. 1) may execute cell acquisition component 30 to abort a wideband cell search procedure 40 on the wideband frequency channel (e.g., communication channel 18) based on the narrowband rejection procedure 38 determining that the plurality of signal power measurements 36 correspond to the narrowband signal. Additional example aspects of performing the actions of block 108 are described in detail above with respect to FIGS. 1 and 2, and a further example is described below with respect to FIG. 4.

Referring to FIG. 4, in an additional or alternate operational aspect, a UE such as UE 11 (FIG. 1) may perform an aspect of a method 200 for allowing the UE 11 to identify and reject narrow bandwidth signals received from the wireless communication network 16 via network entity 12. It should be understood that any one or more of the various component and/or subcomponents of cell acquisition component 30 (FIG. 1) may be executed to perform the aspects described herein with respect to each block forming method 200. It should be noted that method 200 may be considered a more detailed implementation of method 100.

In an aspect, at block 202, method 200 may include making a plurality of signal power measurements over a plurality of bandwidths on a wideband frequency channel, wherein the plurality of signal power measurements correspond to a signal received on the wideband frequency channel. For example, as described herein, UE 11 (FIG. 1) may execute cell acquisition component 30 and/or measurement component 32 to make a plurality of signal power measurements 36 over a plurality of bandwidths on a wideband frequency channel (e.g., communication channel 18), wherein the plurality of signal power measurements 36 correspond to a signal 34 received on the wideband frequency channel (e.g., communication channel 18). Additional example aspects of performing the actions of block 202 are described in detail above with respect to FIGS. 1 and 2.

At block 204, method 200 may include determining a minimum signal power measurement from the plurality of signal power measurements and a maximum signal power measurement from the plurality of signal power measurements. For example, as described herein, UE 11 (FIG. 1) may execute cell acquisition component 30 and/or computing component 62 to determine a minimum signal power 64 measurement from the plurality of signal power measurements 36 and a maximum signal power 66 measurement from the plurality of signal power measurements 36. Additional example aspects of performing the actions of block 204 are described in detail above with respect to FIGS. 1 and 2.

At block 206, method 200 may include computing a first narrowband value and a second narrowband value based on one or more of the minimum signal power signal, the maximum signal power signal, and one of the plurality of signal power measurements. For example, as described herein, UE 11 (FIG. 1) may execute cell acquisition component 30 and/or computing component 62 to compute a first narrowband value 68 and a second narrowband value 70 based on one or more of the minimum signal power 64, the maximum signal power 66, and one of the plurality of signal power measurements 36. In some instances, the one of the plurality of signal power measurements 36 may correspond to a wideband frequency measurement 48. Additional example aspects of performing the actions of block 206 are described in detail above with respect to FIGS. 1 and 2.

Further, at block 208, method 200 may include determining whether first narrowband value exceeds first threshold. For example, as described herein, UE 11 (FIG. 1) may execute cell acquisition component 30 and/or comparing component 72 to determining whether first narrowband value 68 exceeds first threshold 74. If it is determined that first narrowband value 68 exceeds first threshold 74, then method 200 proceeds to block 210. Additional example aspects of performing the actions of block 208 are described in detail above with respect to FIGS. 1 and 2.

At block 210, method 200 may include determining that the plurality of signals power measurements correspond to the narrowband signal, and thus abort the wideband cell acquisition procedure for the wideband channel. For example, as described herein, UE 11 (FIG. 1) may execute cell acquisition component 30 and/or determining component 78 to determine that the plurality of signal power measurements 36 correspond to the narrowband signal when the first narrowband value 68 exceeds the first threshold 74 at block 208. Additional example aspects of performing the actions of block 210 are described in detail above with respect to FIGS. 1 and 2.

Additionally, at block 216, method 200 may include aborting a wideband cell search procedure on the wideband frequency channel based on the narrowband rejection procedure determining that the plurality of signal power measurements correspond to the narrowband signal. For example, as described herein, UE 11 (FIG. 1) may execute cell acquisition component 30 to abort a wideband cell search procedure 40 on the wideband frequency channel (e.g., communication channel 18) based on the narrowband rejection procedure 38 and/or determining component 78 determining that the plurality of signal power measurements 36 correspond to the narrowband signal. Additional example aspects of performing the actions of block 216 are described in detail above with respect to FIGS. 1 and 2.

Moreover, if it determined that the first narrowband value 68 fails to exceed the first threshold 74, then method 200 proceeds to block 212. At block 212, method 200 may include determining whether the second value exceeds the second threshold and determining whether a received signal power exceeds an initial acquisition threshold when the first narrowband value fails to exceed the first threshold. For example, as described herein, UE 11 (FIG. 1) may execute cell acquisition component 30 and/or comparing component 72 to determine whether the second narrowband value 70 exceeds the second threshold 76 and determine whether a new signal measurement 60 exceeds an initial acquisition threshold 44 when the first narrowband value 68 fails to exceed the first threshold 74. If it is determined that the second narrowband value 70 exceeds the second threshold 76 and it is determined that a new signal measurement 60 exceeds an initial acquisition threshold 44 when the first narrowband value 68 fails to exceed the first threshold 74, then method 200 may proceed to block 210 where UE 11 (FIG. 1) may execute cell acquisition component 30 and/or determining component 78 to determine that the plurality of signal power measurements 36 correspond to the narrowband signal. However, if it is determined that the second narrowband value 70 fails to exceed the second threshold 76 and it is determined that a new signal measurement 60 fails to exceed an initial acquisition threshold 44 when the first narrowband value 68 fails to exceed the first threshold 74 then method 200 may proceed to block 214. Additional example aspects of performing the actions of block 212 are described in detail above with respect to FIGS. 1 and 2.

At block 214, method 200 may include determining that the plurality of signal power measurements correspond to the wideband signal when the second narrowband value fails to meet or exceed the second threshold value, and thus proceed with the wideband cell acquisition procedure for the wideband channel. For example, as described herein, UE 11 (FIG. 1) may execute cell acquisition component 30 and/or determining component 78 to determine that the plurality of signal power measurements 36 correspond to the wideband signal when the second narrowband value 70 fails to meet or exceed the second threshold 76. Additional example aspects of performing the actions of block 214 are described in detail above with respect to FIGS. 1 and 2.

Further, at block 218, method 200 may include continuing a wideband cell search procedure 40 on the wideband frequency channel based on the narrowband rejection procedure determining that the plurality of signal power measurements correspond to the wideband signal. For example, as described herein, UE 11 (FIG. 1) may execute cell acquisition component 30 to continue a wideband cell search procedure 40 on the wideband frequency channel (e.g., communication channel 18) based on the narrowband rejection procedure 38 determining that the plurality of signal power measurements 36 correspond to the wideband signal. Additional example aspects of performing the actions of block 218 are described in detail above with respect to FIGS. 1 and 2.

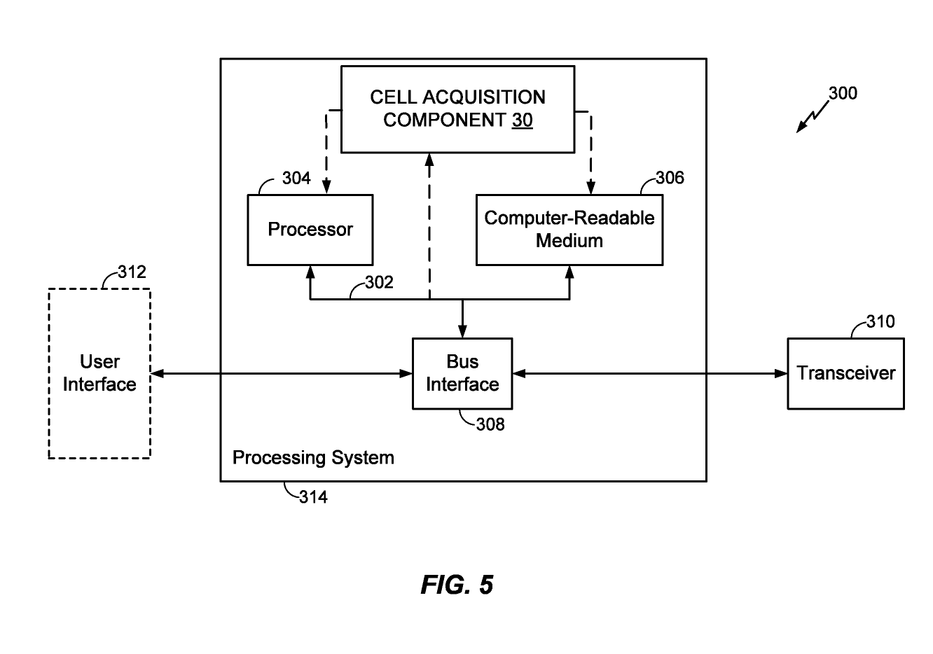

FIG. 5 is a block diagram illustrating an example of a hardware implementation for an apparatus 300 employing a processing system 314, where apparatus 300 may be UE 11 (FIG. 1) or may be included with UE 11, and where apparatus 300 is configured with cell acquisition component 30 for performing the actions described herein. For instance, cell acquisition component 30 may be a separate hardware and/or software component within processing system 314, or cell acquisition component 30 may be define in one or more processor modules of processor 304 or as code stored in computer readable medium 306 and executable by processor 304. In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors, represented generally by the processor 304, and computer-readable media, represented generally by the computer-readable medium 306. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 312 (e.g., keypad, display, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described infra for any particular apparatus. The computer-readable medium 306 may also be used for storing data that is manipulated by the processor 304 when executing software. The cell acquisition component 30 may be a part of processor 304 and/or computer-readable medium 306.

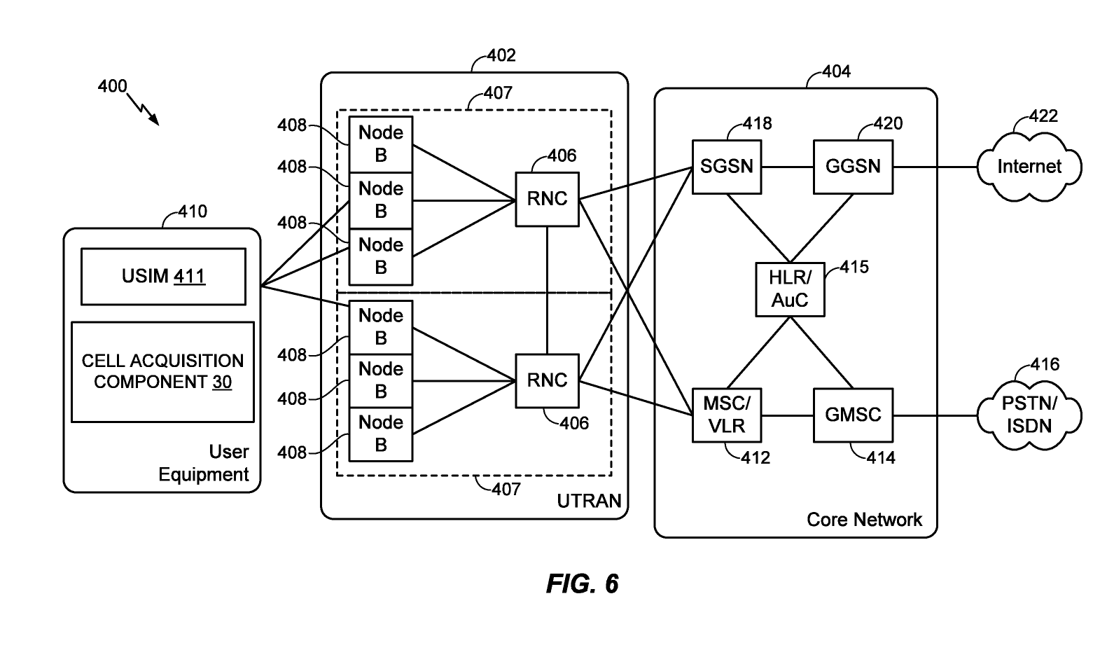

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 400 employing a W-CDMA air interface. In this case, user equipment 410 may be the same as or similar to UE 11 of FIG. 1, and may include cell acquisition component 30 as described herein. A UMTS network includes three interacting domains: a Core Network (CN) 404, a UMTS Terrestrial Radio Access Network (UTRAN) 402, and User Equipment (UE) 410. In this example, the UTRAN 402 provides various wireless services including telephony, video, data, messaging, broadcasts, and/or other services. The UTRAN 402 may include a plurality of Radio Network Subsystems (RNSs) such as an RNS 407, each controlled by a respective Radio Network Controller (RNC) such as an RNC 406. Here, the UTRAN 402 may include any number of RNCs 406 and RNSs 407 in addition to the RNCs 406 and RNSs 407 illustrated herein. The RNC 406 is an apparatus responsible for, among other things, assigning, reconfiguring and releasing radio resources within the RNS 407. The RNC 406 may be interconnected to other RNCs (not shown) in the UTRAN 402 through various types of interfaces such as a direct physical connection, a virtual network, or the like, using any suitable transport network.

Communication between a UE 410 and a Node B 408 may be considered as including a physical (PHY) layer and a medium access control (MAC) layer. Further, communication between a UE 410 and an RNC 406 by way of a respective Node B 408 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 408 are shown in each RNS 407; however, the RNSs 407 may include any number of wireless Node Bs. The Node Bs 408 provide wireless access points to a CN 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 410 may further include a universal subscriber identity module (USIM) 411, which contains a user's subscription information to a network. For illustrative purposes, one UE 410 is shown in communication with a number of the Node Bs 408. The DL, also called the forward link, refers to the communication link from a Node B 408 to a UE 410, and the UL, also called the reverse link, refers to the communication link from a UE 410 to a Node B 408.

The CN 404 interfaces with one or more access networks, such as the UTRAN 402. As shown, the CN 404 is a GSM core network. However, as those skilled in the art will recognize, the various concepts presented throughout this disclosure may be implemented in a RAN, or other suitable access network, to provide UEs with access to types of CNs other than GSM networks.

The CN 404 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 404 supports circuit-switched services with a MSC 412 and a GMSC 414. In some applications, the GMSC 414 may be referred to as a media gateway (MGW). One or more RNCs, such as the RNC 406, may be connected to the MSC 412. The MSC 412 is an apparatus that controls call setup, call routing, and UE mobility functions. The MSC 412 also includes a VLR that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) 415 containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR 415 to determine the UE's location and forwards the call to the particular MSC serving that location.

The CN 404 also supports packet-data services with a serving GPRS support node (SGSN) 418 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 402 to a packet-based network 422. The packet-based network 422 may be the Internet, a private data network, or some other suitable packet-based network. The primary function of the GGSN 220 is to provide the UEs 410 with packet-based network connectivity. Data packets may be transferred between the GGSN 220 and the UEs 410 through the SGSN 418, which performs primarily the same functions in the packet-based domain as the MSC 412 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 408 and a UE 410. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 410 provides feedback to the node B 408 over the HS-DPCCH to indicate whether it correctly decoded a packet on the downlink.

HS-DPCCH further includes feedback signaling from the UE 410 to assist the node B 408 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 408 and/or the UE 410 may have multiple antennas supporting MIMO technology. The use of MIMO technology enables the node B 408 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 410 to increase the data rate or to multiple UEs 410 to increase the overall system capacity. This is achieved by spatially precoding each data stream and then transmitting each spatially precoded stream through a different transmit antenna on the downlink. The spatially precoded data streams arrive at the UE(s) 410 with different spatial signatures, which enables each of the UE(s) 410 to recover the one or more the data streams destined for that UE 410. On the uplink, each UE 410 may transmit one or more spatially precoded data streams, which enables the node B 408 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

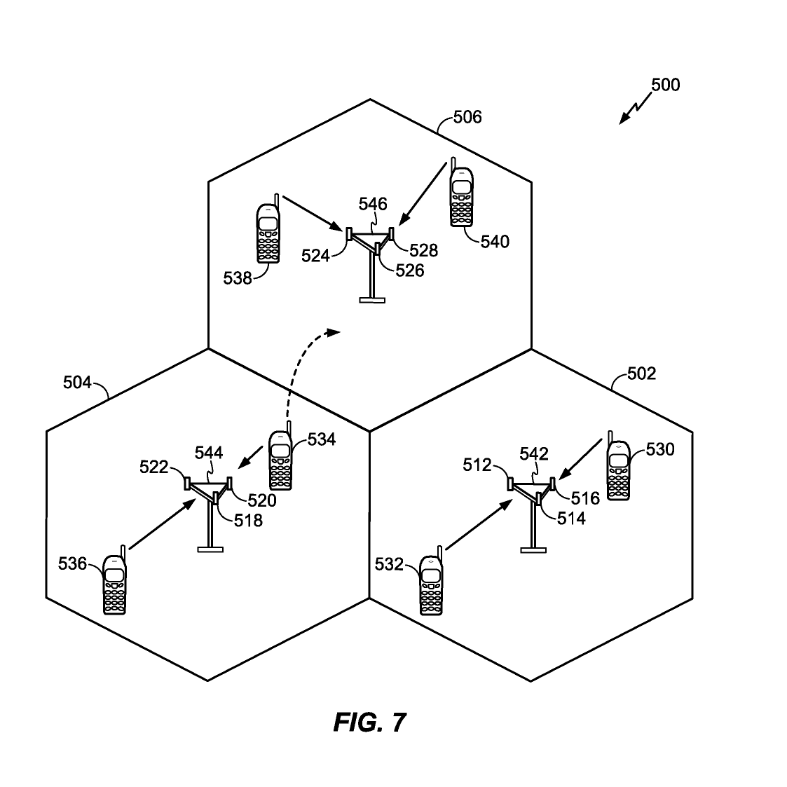

Referring to FIG. 7, an access network 500 in a UTRAN architecture is illustrated. The multiple access wireless communication system includes multiple cellular regions (cells), including cells 502, 504, and 506, each of which may include one or more sectors. The multiple sectors can be formed by groups of antennas with each antenna responsible for communication with UEs in a portion of the cell. For example, in cell 502, antenna groups 512, 514, and 516 may each correspond to a different sector. In cell 504, antenna groups 518, 520, and 522 each correspond to a different sector. In cell 506, antenna groups 524, 526, and 528 each correspond to a different sector. The cells 502, 504 and 506 may include several wireless communication devices, e.g., User Equipment or UEs, which may be in communication with one or more sectors of each cell 502, 504 or 506. For example, UEs 530 and 532 may be in communication with Node B 542, UEs 534 and 536 may be in communication with Node B 544, and UEs 538 and 540 can be in communication with Node B 546. Here, each Node B 542, 544, 546 is configured to provide an access point to a CN 404 (see FIG. 6) for all the UEs 530, 532, 534, 536, 538, 540 in the respective cells 502, 504, and 506. UEs 530, 532, 534, 536, 538, 540 may correspond to UE 11 (FIG. 1) configured to execute cell acquisition component 30.

As the UE 534 moves from the illustrated location in cell 504 into cell 506, a serving cell change (SCC) or handover may occur in which communication with the UE 534 transitions from the cell 504, which may be referred to as the source cell, to cell 506, which may be referred to as the target cell. Management of the handover procedure may take place at the UE 534, at the Node Bs corresponding to the respective cells, at a radio network controller 406 (see FIG. 6), or at another suitable node in the wireless network. For example, during a call with the source cell 504, or at any other time, the UE 534 may monitor various parameters of the source cell 504 as well as various parameters of neighboring cells such as cells 506 and 502. Further, depending on the quality of these parameters, the UE 534 may maintain communication with one or more of the neighboring cells. During this time, the UE 534 may maintain an Active Set, that is, a list of cells that the UE 534 is simultaneously connected to (i.e., the UTRA cells that are currently assigning a downlink dedicated physical channel DPCH or fractional downlink dedicated physical channel F-DPCH to the UE 534 may constitute the Active Set).

The modulation and multiple access scheme employed by the access network 500 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

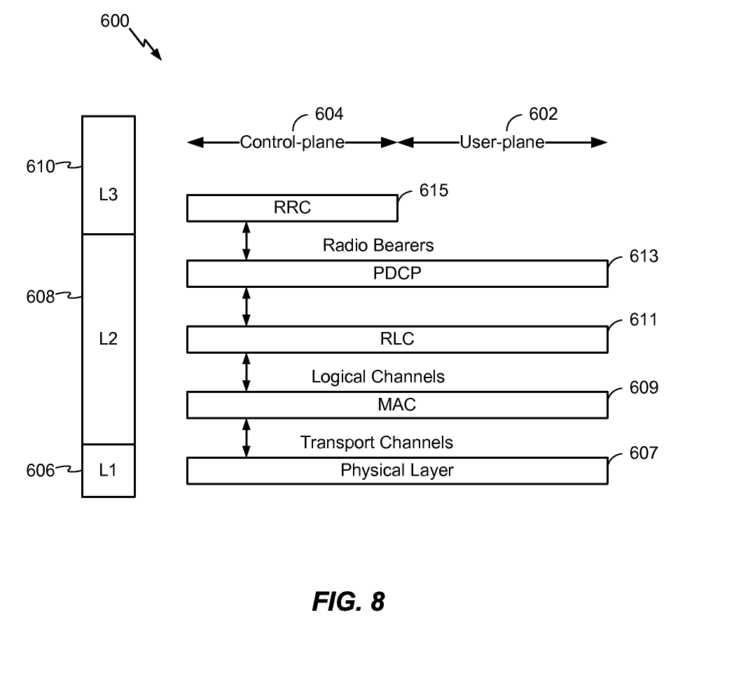

The radio protocol architecture may take on various forms depending on the particular application. An example for an HSPA system will now be presented with reference to FIG. 8.

Referring to FIG. 8 an example radio protocol architecture 600 relates to the user plane 602 and the control plane 604 of a user equipment (UE) or node B/base station. For example, architecture 600 may be included in a UE such as UE 11 (FIG. 1) configured to execute cell acquisition component 30. The radio protocol architecture 600 for the UE and node B is shown with three layers: Layer 1 606, Layer 2 608, and Layer 3 610. Layer 1 606 is the lowest lower and implements various physical layer signal processing functions. As such, Layer 1 606 includes the physical layer 607. Layer 2 (L2 layer) 608 is above the physical layer 607 and is responsible for the link between the UE and node B over the physical layer 607. Layer 3 (L3 layer) 610 includes a radio resource control (RRC) sublayer 615. The RRC sublayer 615 handles the control plane signaling of Layer 3 between the UE and the UTRAN.

In the user plane, the L2 layer 608 includes a media access control (MAC) sublayer 609, a radio link control (RLC) sublayer 611, and a packet data convergence protocol (PDCP) 613 sublayer, which are terminated at the node B on the network side. Although not shown, the UE may have several upper layers above the L2 layer 608 including a network layer (e.g., IP layer) that is terminated at a PDN gateway on the network side, and an application layer that is terminated at the other end of the connection (e.g., far end UE, server, etc.).

The PDCP sublayer 613 provides multiplexing between different radio bearers and logical channels. The PDCP sublayer 613 also provides header compression for upper layer data packets to reduce radio transmission overhead, security by ciphering the data packets, and handover support for UEs between node Bs. The RLC sublayer 611 provides segmentation and reassembly of upper layer data packets, retransmission of lost data packets, and reordering of data packets to compensate for out-of-order reception due to hybrid automatic repeat request (HARQ). The MAC sublayer 609 provides multiplexing between logical and transport channels. The MAC sublayer 609 is also responsible for allocating the various radio resources (e.g., resource blocks) in one cell among the UEs. The MAC sublayer 609 is also responsible for HARQ operations.

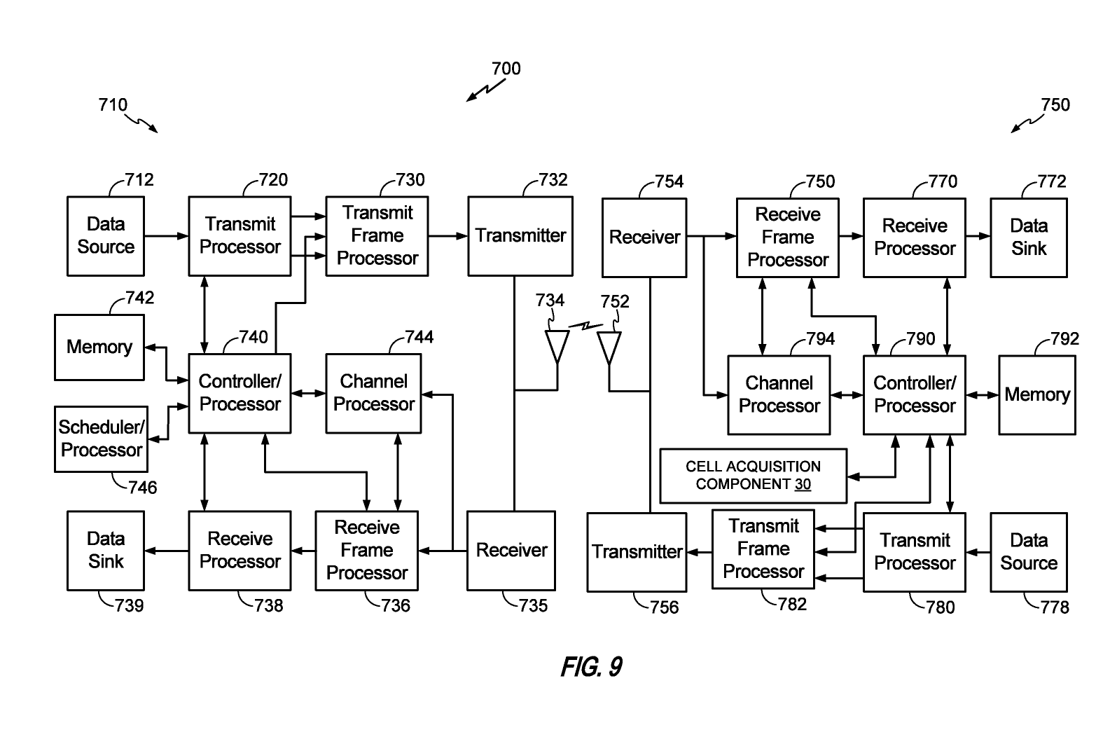

FIG. 9 is a block diagram of a Node B 710 in communication with a UE 750, where the Node B 710 may be the Node B 208 in FIG. 5, and the UE 750 may be the UE 410 in FIG. 6, including the cell acquisition component 30 for performing the actions described herein. In the downlink communication, a transmit processor 720 may receive data from a data source 812 and control signals from a controller/processor 740. The transmit processor 720 provides various signal processing functions for the data and control signals, as well as reference signals (e.g., pilot signals). For example, the transmit processor 720 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 744 may be used by a controller/processor 740 to determine the coding, modulation, spreading, and/or scrambling schemes for the transmit processor 720. These channel estimates may be derived from a reference signal transmitted by the UE 750 or from feedback from the UE 750. The symbols generated by the transmit processor 720 are provided to a transmit frame processor 730 to create a frame structure. The transmit frame processor 730 creates this frame structure by multiplexing the symbols with information from the controller/processor 740, resulting in a series of frames. The frames are then provided to a transmitter 732, which provides various signal conditioning functions including amplifying, filtering, and modulating the frames onto a carrier for downlink transmission over the wireless medium through antenna 734. The antenna 734 may include one or more antennas, for example, including beam steering bidirectional adaptive antenna arrays or other similar beam technologies.

At the UE 750, a receiver 754 receives the downlink transmission through an antenna 752 and processes the transmission to recover the information modulated onto the carrier. The information recovered by the receiver 754 is provided to a receive frame processor 760, which parses each frame, and provides information from the frames to a channel processor 794 and the data, control, and reference signals to a receive processor 770. The receive processor 770 then performs the inverse of the processing performed by the transmit processor 720 in the Node B 710. More specifically, the receive processor 770 descrambles and despreads the symbols, and then determines the most likely signal constellation points transmitted by the Node B 710 based on the modulation scheme. These soft decisions may be based on channel estimates computed by the channel processor 794. The soft decisions are then decoded and deinterleaved to recover the data, control, and reference signals. The CRC codes are then checked to determine whether the frames were successfully decoded. The data carried by the successfully decoded frames will then be provided to a data sink 772, which represents applications running in the UE 750 and/or various user interfaces (e.g., display). Control signals carried by successfully decoded frames will be provided to a controller/processor 790. When frames are unsuccessfully decoded by the receiver processor 770, the controller/processor 790 may also use an acknowledgement (ACK) and/or negative acknowledgement (NACK) protocol to support retransmission requests for those frames.

In the uplink, data from a data source 778 and control signals from the controller/processor 790 are provided to a transmit processor 780. The data source 778 may represent applications running in the UE 750 and various user interfaces (e.g., keyboard). Similar to the functionality described in connection with the downlink transmission by the Node B 710, the transmit processor 780 provides various signal processing functions including CRC codes, coding and interleaving to facilitate FEC, mapping to signal constellations, spreading with OVSFs, and scrambling to produce a series of symbols. Channel estimates, derived by the channel processor 794 from a reference signal transmitted by the Node B 710 or from feedback contained in the midamble transmitted by the Node B 710, may be used to select the appropriate coding, modulation, spreading, and/or scrambling schemes. The symbols produced by the transmit processor 780 will be provided to a transmit frame processor 782 to create a frame structure. The transmit frame processor 782 creates this frame structure by multiplexing the symbols with information from the controller/processor 790, resulting in a series of frames. The frames are then provided to a transmitter 856, which provides various signal conditioning functions including amplification, filtering, and modulating the frames onto a carrier for uplink transmission over the wireless medium through the antenna 752.

The uplink transmission is processed at the Node B 710 in a manner similar to that described in connection with the receiver function at the UE 750. A receiver 735 receives the uplink transmission through the antenna 734 and processes the transmission to recover the information modulated onto the carrier. The information recovered by the receiver 735 is provided to a receive frame processor 736, which parses each frame, and provides information from the frames to the channel processor 744 and the data, control, and reference signals to a receive processor 738. The receive processor 738 performs the inverse of the processing performed by the transmit processor 780 in the UE 750. The data and control signals carried by the successfully decoded frames may then be provided to a data sink 739 and the controller/processor, respectively. If some of the frames were unsuccessfully decoded by the receive processor, the controller/processor 740 may also use an acknowledgement (ACK) and/or negative acknowledgement (NACK) protocol to support retransmission requests for those frames.

The controller/processors 740 and 790 may be used to direct the operation at the Node B 710 and the UE 750, respectively. For example, the controller/processors 740 and 790 may provide various functions including timing, peripheral interfaces, voltage regulation, power management, and other control functions. The computer readable media of memories 742 and 792 may store data and software for the Node B 710 and the UE 750, respectively. A scheduler/processor 746 at the Node B 710 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method at a user equipment for performing a cell search procedure during wireless communications, comprising:
making a plurality of signal power measurements over a plurality of bandwidths on a wideband frequency channel, wherein the plurality of signal power measurements correspond to a signal received on the wideband frequency channel;
performing a narrowband rejection procedure based on the plurality of signal power measurements, wherein the narrowband rejection procedure determines whether the plurality of signal power measurements correspond to a narrowband signal or a wideband signal; and
continuing a wideband cell search procedure on the wideband frequency channel based on the narrowband rejection procedure determining that the plurality of signal power measurements correspond to the wideband signal.

2. The method of claim 1, further comprising:
wherein the making of the plurality of signal power measurements further comprises:
making a wideband frequency measurement over a wideband frequency bandwidth corresponding to the wideband frequency channel; and
making a plurality of narrowband frequency measurements over a corresponding plurality of different narrowband frequency bandwidths within the wideband frequency channel; and
determining presence of the wideband signal or the narrowband signal based on comparing values of at least two of the wideband frequency measurement and the plurality of narrowband frequency measurements.

3. The method of claim 2, wherein the wideband frequency measurement is centered on the wideband frequency bandwidth.

4. The method of claim 2, wherein the plurality of narrowband frequency measurements include one or more frequency measurements centered on one of the corresponding plurality of different narrowband frequency bandwidths, frequency measurements rotated by a positive offset on one of the corresponding plurality of different narrowband frequency bandwidths, and frequency measurements rotated by a negative offset on one of the corresponding plurality of different narrowband frequency bandwidths.

5. The method of claim 1, further comprising:
aborting a wideband cell search procedure on the wideband frequency channel based on the narrowband rejection procedure determining that the plurality of signal power measurements correspond to the narrowband signal.

6. The method of claim 1, wherein performing the narrowband rejection procedure comprises:
determining a minimum signal power measurement from the plurality of signal power measurements and a maximum signal power measurement from the plurality of signal power measurements;
computing a first narrowband value and a second narrowband value based on one or more of the minimum signal power measurement, the maximum signal power measurement, and one of the plurality of signal power measurements;
comparing the first narrowband value to a first threshold;
determining that the plurality of signal power measurements correspond to the narrowband signal when the first value exceeds the first threshold;
comparing the second narrowband value to a second threshold when a determination is made that the first narrowband value fails to meet or exceed the first threshold; and
determining that the signal is the narrowband signal when the second narrowband value exceeds the second threshold; and
determining that the signal corresponds to the wideband signal when a determination is made that the second narrowband value fails to meet or exceed the second threshold.

7. The method of claim 6, further comprising:
determining whether a received signal power exceeds an initial acquisition threshold when the first narrowband value fails to exceed the first threshold; and
determining that the plurality of signal power measurements correspond to the wideband signal when the received signal power exceeds the initial acquisition threshold.

8. The method of claim 1, further comprising:
performing a frequency scan on a plurality of wideband channels;
measuring a received signal power on each of the plurality of wideband channels based on the frequency scan; and
choosing one of the plurality of wideband channels based on the received signal power on each of the plurality of wideband channels, wherein the one of the plurality of wideband channels with a highest received signal power is chosen.

9. A computer-readable medium storing computer executable code at a user equipment for performing a cell search procedure during wireless communication, comprising:
code for making a plurality of signal power measurements over a plurality of bandwidths on a wideband frequency channel, wherein the plurality of signal power measurements correspond to a signal received on the wideband frequency channel;
code for performing a narrowband rejection procedure based on the plurality of signal power measurements, wherein the narrowband rejection procedure determines whether the plurality of signal power measurements correspond to a narrowband signal or a wideband signal; and
code for continuing a wideband cell search procedure on the wideband frequency channel based on the narrowband rejection procedure determining that the plurality of signal power measurements correspond to the wideband signal.

10. The computer-readable medium of claim 9, further comprising:
wherein the code for making of the plurality of signal power measurements further comprises:
code for making a wideband frequency measurement over a wideband frequency bandwidth corresponding to the wideband frequency channel, wherein the wideband frequency measurement is centered on the wideband frequency bandwidth; and
code for making a plurality of narrowband frequency measurements over a corresponding plurality of different narrowband frequency bandwidths within the wideband frequency channel; and
code for determining presence of the wideband signal or the narrowband signal based on comparing values of at least two of the wideband frequency measurement and the plurality of narrowband frequency measurements.

11. The computer-readable medium of claim 10, wherein the plurality of narrowband frequency measurements include one or more frequency measurements centered on one of the corresponding plurality of different narrowband frequency bandwidths, frequency measurements rotated by a positive offset on one of the corresponding plurality of different narrowband frequency bandwidths, and frequency measurements rotated by a negative offset on one of the corresponding plurality of different narrowband frequency bandwidths.

12. The computer-readable medium of claim 9, further comprising:
code for aborting a wideband cell search procedure on the wideband frequency channel based on the narrowband rejection procedure determining that the plurality of signal power measurements correspond to the narrowband signal.

13. The computer-readable medium of claim 9, wherein the code for performing the narrowband rejection procedure comprises:
code for determining a minimum signal power measurement from the plurality of signal power measurements and a maximum signal power measurement from the plurality of signal power measurements;
code for computing a first narrowband value and a second narrowband value based on one or more of the minimum signal power measurement, the maximum signal power measurement, and one of the plurality of signal power measurements;
code for comparing the first narrowband value to a first threshold;
code for determining that the plurality of signal power measurements correspond to the narrowband signal when the first value exceeds the first threshold;
code for comparing the second narrowband value to a second threshold when a determination is made that the first narrowband value fails to meet or exceed the first threshold; and
code for determining that the signal is the narrowband signal when the second narrowband value exceeds the second threshold; and
code for determining that the signal corresponds to the wideband signal when a determination is made that the second narrowband value fails to meet or exceed the second threshold.

14. The computer-readable medium of claim 13, further comprising:
code for determining whether a received signal power exceeds an initial acquisition threshold when the first narrowband value fails to exceed the first threshold; and
code for determining that the plurality of signal power measurements correspond to the wideband signal when the received signal power exceeds the initial acquisition threshold.

15. The computer-readable medium of claim 9, further comprising:
code for performing a frequency scan on a plurality of wideband channels;
code for measuring a received signal power on each of the plurality of wideband channels based on the frequency scan; and
code for choosing one of the plurality of wideband channels based on the received signal power on each of the plurality of wideband channels, wherein the one of the plurality of wideband channels with a highest received signal power is chosen.

16. An apparatus at a user equipment for performing a cell search procedure during wireless communication, comprising:
means for making a plurality of signal power measurements over a plurality of bandwidths on a wideband frequency channel, wherein the plurality of signal power measurements correspond to a signal received on the wideband frequency channel;
means for performing a narrowband rejection procedure based on the plurality of signal power measurements, wherein the narrowband rejection procedure determines whether the plurality of signal power measurements correspond to a narrowband signal or a wideband signal; and
means for continuing a wideband cell search procedure on the wideband frequency channel based on the narrowband rejection procedure determining that the plurality of signal power measurements correspond to the wideband signal.

17. The apparatus of claim 16, further comprising:
wherein the means for making of the plurality of signal power measurements further comprises:
means for making a wideband frequency measurement over a wideband frequency bandwidth corresponding to the wideband frequency channel, wherein the wideband frequency measurement is centered on the wideband frequency bandwidth; and
means for making a plurality of narrowband frequency measurements over a corresponding plurality of different narrowband frequency bandwidths within the wideband frequency channel; and
means for determining presence of the wideband signal or the narrowband signal based on comparing values of at least two of the wideband frequency measurement and the plurality of narrowband frequency measurements.

18. The apparatus of claim 17, wherein the plurality of narrowband frequency measurements include one or more frequency measurements centered on one of the corresponding plurality of different narrowband frequency bandwidths, frequency measurements rotated by a positive offset on one of the corresponding plurality of different narrowband frequency bandwidths, and frequency measurements rotated by a negative offset on one of the corresponding plurality of different narrowband frequency bandwidths.

19. The apparatus of claim 16, further comprising:
means for aborting a wideband cell search procedure on the wideband frequency channel based on the narrowband rejection procedure determining that the plurality of signal power measurements correspond to the narrowband signal.

20. The apparatus of claim 16, wherein the means for performing the narrowband rejection procedure comprises:
means for determining a minimum signal power measurement from the plurality of signal power measurements and a maximum signal power measurement from the plurality of signal power measurements;
means for computing a first narrowband value and a second narrowband value based on one or more of the minimum signal power measurement, the maximum signal power measurement, and one of the plurality of signal power measurements;
means for comparing the first narrowband value to a first threshold;
means for determining that the plurality of signal power measurements correspond to the narrowband signal when the first value exceeds the first threshold;
means for comparing the second narrowband value to a second threshold when a determination is made that the first narrowband value fails to meet or exceed the first threshold; and
means for determining that the signal is the narrowband signal when the second narrowband value exceeds the second threshold; and
means for determining that the signal corresponds to the wideband signal when a determination is made that the second narrowband value fails to meet or exceed the second threshold.

21. The apparatus of claim 20, further comprising:
means for determining whether a received signal power exceeds an initial acquisition threshold when the first narrowband value fails to exceed the first threshold; and
means for determining that the plurality of signal power measurements correspond to the wideband signal when the received signal power exceeds the initial acquisition threshold.

22. The apparatus of claim 16, further comprising:
means for performing a frequency scan on a plurality of wideband channels;
means for measuring a received signal power on each of the plurality of wideband channels based on the frequency scan; and
means for choosing one of the plurality of wideband channels based on the received signal power on each of the plurality of wideband channels, wherein the one of the plurality of wideband channels with a highest received signal power is chosen.

23. An apparatus at a user equipment for performing a cell search procedure during wireless communication, comprising:
a measurement component configured to make a plurality of signal power measurements over a plurality of bandwidths on a wideband frequency channel, wherein the plurality of signal power measurements correspond to a signal received on the wideband frequency channel;
a cell acquisition component configured to perform a narrowband rejection procedure based on the plurality of signal power measurements, wherein the narrowband rejection procedure determines whether the plurality of signal power measurements correspond to a narrowband signal or a wideband signal; and
wherein the cell acquisition component is further configured to continue a wideband cell search procedure on the wideband frequency channel based on the narrowband rejection procedure determining that the plurality of signal power measurements correspond to the wideband signal.

24. The apparatus of claim 23, wherein the measurement component is further configured to:
make a wideband frequency measurement over a wideband frequency bandwidth corresponding to the wideband frequency channel; and
make a plurality of narrowband frequency measurements over a corresponding plurality of different narrowband frequency bandwidths within the wideband frequency channel; and
determine presence of the wideband signal or the narrowband signal based on comparing values of at least two of the wideband frequency measurement and the plurality of narrowband frequency measurements.

25. The apparatus of claim 24, wherein the wideband frequency measurement is centered on the wideband frequency bandwidth.

26. The apparatus of claim 24, wherein the plurality of narrowband frequency measurements include one or more frequency measurements centered on one of the corresponding plurality of different narrowband frequency bandwidths, frequency measurements rotated by a positive offset on one of the corresponding plurality of different narrowband frequency bandwidths, and frequency measurements rotated by a negative offset on one of the corresponding plurality of different narrowband frequency bandwidths.

27. The apparatus of claim 23, wherein the cell acquisition component is further configured to abort a wideband cell search procedure on the wideband frequency channel based on the narrowband rejection procedure determining that the plurality of signal power measurements correspond to the narrowband signal.

28. The apparatus of claim 23, wherein the measurement component is further configured to:
determine a minimum signal power measurement from the plurality of signal power measurements and a maximum signal power measurement from the plurality of signal power measurements;
compute a first narrowband value and a second narrowband value based on one or more of the minimum signal power measurement, the maximum signal power measurement, and one of the plurality of signal power measurements;
a comparing component configured to compare the first narrowband value to a first threshold;
a determining component configured to determine that the plurality of signal power measurements correspond to the narrowband signal when the first value exceeds the first threshold;
wherein the comparing component is further configured to compare the second narrowband value to a second threshold when a determination is made that the first narrowband value fails to meet or exceed the first threshold; and
wherein the determining component is further configured to determine that the signal is the narrowband signal when the second narrowband value exceeds the second threshold; and
wherein the determining component is further configured to determine that the signal corresponds to the wideband signal when a determination is made that the second narrowband value fails to meet or exceed the second threshold.

29. The apparatus of claim 28, wherein the determining component is further configured to:
determine whether a received signal power exceeds an initial acquisition threshold when the first narrowband value fails to exceed the first threshold; and
determine that the plurality of signal power measurements correspond to the wideband signal when the received signal power exceeds the initial acquisition threshold.

30. The apparatus of claim 23, wherein the cell acquisition component is further configured to:
perform a frequency scan on a plurality of wideband channels;
measure a received signal power on each of the plurality of wideband channels based on the frequency scan; and
choose one of the plurality of wideband channels based on the received signal power on each of the plurality of wideband channels, wherein the one of the plurality of wideband channels with a highest received signal power is chosen.
